(19) United States
(12) Patent Application Publication
(10) Pub. No.: US 2012/0055997 A1
(43) Pub. Date: Mar. 8, 2012

(54) IDENTIFICATION SYSTEM FOR OBJECTS OR PRODUCTS ON A DISPLAY

(75) Inventor: Sander De Ridder, Almere (NL)

(73) Assignee: Capturetech B.V., PJ Nieuw Vennep (NL)

(21) Appl. No.: 13/203,375

(22) PCT Filed: Feb. 9, 2010
(86) PCT No.: PCT/NL2010/050058

§ 371 Date: Oct. 3, 2011

(30) Foreign Application Priority Data
Feb. 25, 2009 (NL) 2002564

(51) Int. Cl. H01Q 1/44; G06K 19/06

(52) U.S. Cl. 235/492; 343/720

(57) ABSTRACT

There is disclosed an identification system which comprises electromagnetic identification means to be connected to objects, such as products, files, keys, file documents, suspension files and the like, and communication means provided with antennas for communication with the identification means. The system further comprises display means for the objects, which form the antennas, via which regular communication with the identification means takes place. Advantageously, the antennas perform a dual function as transmitters of electromagnetic radiation and as support or suspension elements for the objects, without this being realised at the expense of the advantages of the known identification systems.

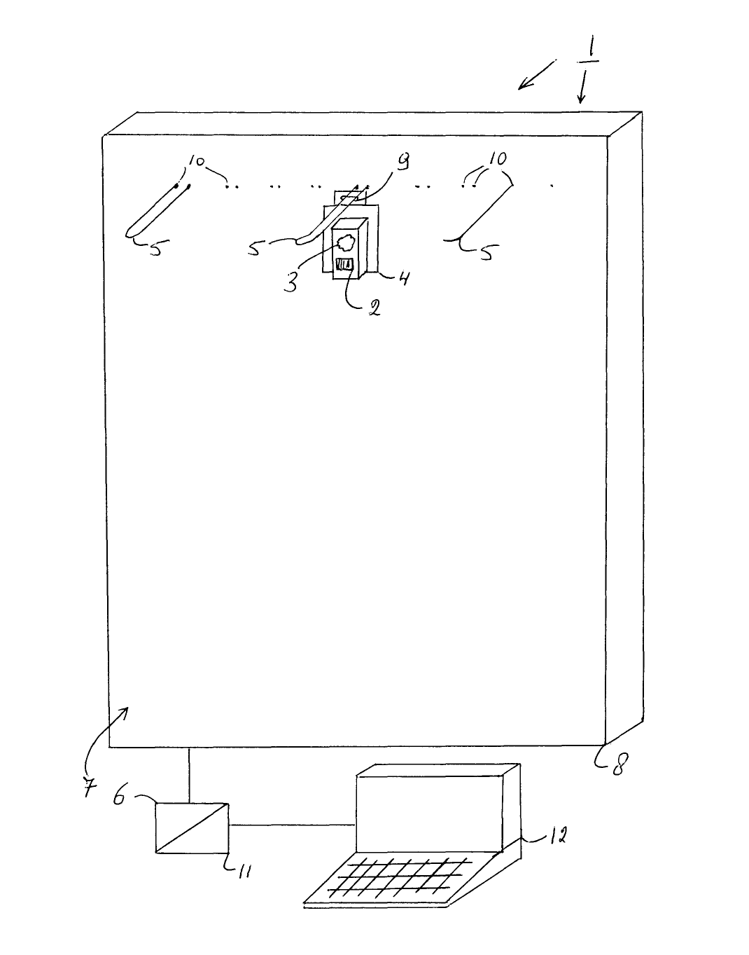

The present invention relates to an identification system comprising electromagnetic identification means to be connected to or incorporated into objects, products, files, keys, file documents and the like, communication means provided with antennas for communication with the identification means, and display means for the articles.

The present invention further relates to the use of such an identification system, to an article display or an article display wall provided with antennas for an identification system, to a method wherein the presence of objects provided with electromagnetic identification means on a display (wall) and the removal of said objects therefrom is detected by the identification system, as well as to a computer system which is programmed to carry out the above method.

Such an identification system is known from WO 205/116945. The known identification system comprises objects provided with radio-frequency (RF) identification tags and communication means comprising RF antennas for communication with the identification means on the objects. The objects lie or stand on display means in the form of shelves, in which the antennas are incorporated.

The object of the present invention is to provide an identification system which comprises fewer parts and which further has the same advantageous functionality as the known systems.

In order to accomplish that object, the identification system according to the invention is characterised in that said display means are the antennas.

The identification system according to the invention has the advantage that, in accordance with the invention, the antennas are given a display or support or suspension function, as it were, so that separate display means such as the shelves used in the above-described prior art are no longer needed. The display function and the classic display means for the objects are no longer needed, in their place antennas are used which must be capable of taking up the mechanical forces that are inherent to the new use as a support element for the objects. Advantageously, the antennas thus perform a dual function as transmitters of electromagnetic radiation and as support elements for the objects, without this being realised at the expense of the advantages of the known identification systems.

One embodiment of the identification system according to the invention is characterised in that the display means are configured as support or suspension elements for the objects. In practice, the aforesaid elements are connected to packages in which the objects are packaged or by which the objects are enveloped.

Advantageously, these so-called blister packs are generally directly suspended from the antennas.

In a simple embodiment, the identification system according to the invention is characterised in that the envelope or package is provided with an opening which is configured for insertion of the display means provided with hooks therein.

The advantage of this is that the antennas can be of simple design, for example as simple hooks which can be made of a material, for example a usual metal, which is capable of transmitting and receiving radiation in a limited area around the hooks from which the objects provided with the electromagnetic identification means are suspended.

Another embodiment of the identification system according to the invention is characterised in that the communication means comprise at least one multiplexer, which is connected to the identification means on the available objects through the air via the display means configured as antennas.

The advantage of this embodiment of the identification system according to the invention is that the multiplexer is capable of identifying the objects connected to each antenna, for example being suspended therefrom, individually via their identification means. Following this, a database can be built up and kept up to date using suitable software and a usual computer system, for example for stock management, general management or stocktaking. Furthermore, an object tracking and automatic ordering system, for example for sales purposes in shops, can be realised by means of this system for those cases in which objects are no longer present near the respective antennas. Furthermore, objects suspended from the wrong hooks can read out and traced, so that they can be put back at the correct position, for example on the wall of a display.

Now in particular the identification system according to the present invention will be explained in more detail with reference to the appended FIGURE, which shows a simplified complete overview of a combination of possible embodiments of an identification system according to the invention.

The FIGURE schematically shows an identification system 1. The system 1 comprises electromagnetic, for example radio-frequency (RF), identification (ID) means 2, which, in this embodiment, are connected to objects 3, such as products, files, articles, but possibly also file documents, suspension files, keys or the like. In the illustrated embodiment, the ID means 2 are attached to a package 4 in which the object 3 is packaged. The means 2 may also be directly attached to the object 3. The system 1 further comprises communication means 6 provided with antennas 5, which are designed for communication with the electromagnetic ID means 2 through the air via the antennas 5. For the sake of simplicity of explanation, the identification 1 shown herein will be further explained on the basis of a display 7 as shown, which is provided with a board 8, on which generally several objects 1 intended for sale, distribution, lending or hiring out, for example, are present. The illustrated display 7 is suitable for placement in a sales space of a store, so that the buying public can take the products they want from said display. The illustrated objects are directly suspended from the antennas 5 with their packages, which antennas are configured as support means or, as shown, suspension means for the objects. The objects 3 may be directly supported on the antennas, without additional display means being required.

The illustrated package 4 is provided with an opening 9, which is configured for insertion of the antennas 5 provided with hooks 5 therein. Said hooks may be single or multiple folded (wire) antennas 5, in particular open or folded dipole antennas 5. The length L by which the antenna 5 projects from the display 7 on the illustrated object-carrying side is related to the wavelength of the electromagnetic radiation by means of which communication between the communication means 6 and the ID means 2, and vice versa, takes place. In the case of a transmission and receiving frequency of between 868 MHz and 870 MHz, the length L ranges between about 15 cm and usually 25 cm at most. The antennas 5 preferably have hooked ends, which are designed for easy insertion into or removal from through holes 10 in the display wall or the display board 8. On the rear side (not shown) of the board 8 are connection ends of the antennas 5, via which all antennas are electrically connected to the communication means 6. The communication means 6 are provided with at least one multiplexer 11, which thus connected to all ID means 2 on the objects 3 through the air via the antennas 5. The multiplexer 11, or multiplexers 11 if necessary, transmit(s) a query signal to the ID means 2 on one particular antenna 5. The ID means 2 configured as labels or tags 2 are capable of transmitting data, in particular identification data, back to the means 6 via said particular antenna 5, in which means said data are processed by suitable software in a computer system 12. Subsequently, a next antenna 5 is addressed for retrieving the data from the labelled objects 3 present thereon and processing said data. Said addressing takes place very quickly and at regular intervals, so that an up-to-date picture, which will be correct at all times, will be available regarding the stock on hand of objects, such as products, articles, keys, files or the like, for example in a store or a warehouse, but also regarding files, archives, file documents, (suspension) files in an archive, library or at other places where such files or documents must be identifiable, available and retraceable. Not only are the objects individually identifiable, using minimal means, but they can also be identified in groups.

Generally, suitable software is available for the computer system 12, which software is designed for setting up and maintaining a database containing the aforesaid data regarding the objects 3.

1. An identification system comprising:
a) electromagnetic identification means to be connected to objects, such as products, files, keys, commodities, file documents, suspension files or the like;
b) communication means provided with antennas for communication with the identification means; and
c) display means for the objects,
characterised in that said display means are the antennas.

2. An identification system according to claim 1, characterised in that the antennas are configured as support or suspension elements for the objects.

3. An identification system according to claim 1 or 2, characterised in that the objects are included in an envelope or package configured for coupling with the antennas.

4. An identification system according to claim 3, characterised in that the object, the envelope and/or the package is provided with an opening which is configured for insertion of the antennas provided with hooks therein.

5. An identification system according to claim 4, characterised in that said hooks are single or multiple folded antennas, in particular open or folded dipole antennas.

6. An identification system according to any one of claims 1-5, characterised in that said antennas are elongate antennas to be electrically connected to the communication means at at least one end.

7. An identification system according to any one of claims 1-6, characterised in that the antennas have possibly hooked ends, which are designed for insertion into a display, a board, a display wall or the like for the objects.

8. An identification system according to any one of claims 1-7, characterised in that the length by which the antenna projects from the display on the side showing the objects is related to the wavelength of the electromagnetic radiation by means of which the communication takes place.

9. An identification system according to any one of claims 1-8, characterised in that the communication means comprise at least one multiplexer, which is coupled to the identification means on the available objects through the air via the display means configured as antennas.

10. An identification system according to any one of claims 1-9, characterised in that said electromagnetic identification means are labels or tags to be connected to the objects.

11. Use of the identification system according to any one of claims 1-10 in a stocktaking, tracking, stock management or management system for objects, such as products, keys, articles, files or the like, for example in a store or a warehouse, but also files, archives, file documents, (suspension) files or the like.

12. An article display, board or display wall provided with display means, preferably hooks, functioning as antennas in an identification system according to any one of claims 1-10.

13. A method wherein the presence of objects provided with identification means on a display and the removal of said objects therefrom is detected by an identification system according to any one of claims 1-10, which further comprises display means in the form of antennas, by means of which the objects are connected to the display, and communication means for regular communication with the identification means on the objects, which may or may not be present on the display.

14. A computer system provided with software designed for maintaining a database containing data regarding objects, which data are at least partially kept up to date by making use of electromagnetic signals being communicated to labels or tags on the objects via the display means in the form of antennas, said data comprising at least data that unequivocally identify individual objects or groups of objects.

15. Software for the computer system according to claim 14, which software is designed for maintaining a database containing data regarding objects, which data are at least partially kept up to date by making use of electromagnetic signals being communicated to labels or tags on the objects via antennas functioning as display means, said data comprising at least data that unequivocally identify individual objects or groups of objects.
